(19) United States
(12) Patent Application Publication
(10) Pub. No.: US 2019/0148774 A1
(43) Pub. Date: May 16, 2019

(54) ELECTROLYTES WITH VINYL CARBONATE AND BUTYRATE SOLVENTS

(71) Applicant: StoreDot Ltd., Herzeliya (IL)

(72) Inventors: Evgenia Liel (Jeny) KUKS, Ramat Gan (IL); Liron AMIR, Ramat Gan (IL); Nir KEDEM, Haifa (IL)

(73) Assignee: StoreDot Ltd., Herzeliya (IL)

(21) Appl. No.: 16/243,190

(22) Filed: Jan. 9, 2019

Related U.S. Application Data
(63) Continuation-in-part of application No. 15/844,689, filed on Dec. 18, 2017, now Pat. No. 10,199,677.
Application No. 15/844,689 is a continuation-in-part of application No. 15/447,889, filed on Mar. 2, 2017, now Pat. No. 10,096,859.
Application No. 15/447,889 is a continuation-in-part of application No. 15/447,784, filed on Mar. 2, 2017.
(60) Provisional application No. 62/319,341, filed on Apr. 7, 2016.
(60) Provisional application No. 62/337,416, filed on May 17, 2016.
(60) Provisional application No. 62/371,874, filed on Aug. 8, 2016.
(60) Provisional application No. 62/401,214, filed on Sep. 29, 2016.
(60) Provisional application No. 62/401,635, filed on Sep. 29, 2016.
(60) Provisional application No. 62/421,290, filed on Nov. 13, 2016.
(60) Provisional application No. 62/426,625, filed on Nov. 28, 2016.
(60) Provisional application No. 62/427,856, filed on Nov. 30, 2016.
(60) Provisional application No. 62/435,783, filed on Dec. 18, 2016.
(60) Provisional application No. 62/441,458, filed on Jan. 2, 2017.
(60) Provisional application No. 62/319,341, filed on Apr. 7, 2016.
(60) Provisional application No. 62/337,416, filed on May 17, 2016.
(60) Provisional application No. 62/371,874, filed on Aug. 8, 2016.
(60) Provisional application No. 62/401,214, filed on Sep. 29, 2016.
(60) Provisional application No. 62/401,635, filed on Sep. 29, 2016.
(60) Provisional application No. 62/421,290, filed on Nov. 13, 2016.
(60) Provisional application No. 62/426,625, filed on Nov. 28, 2016.
(60) Provisional application No. 62/427,856, filed on Nov. 30, 2016.
(60) Provisional application No. 62/435,783, filed on Dec. 18, 2016.
(60) Provisional application No. 62/441,458, filed on Jan. 2, 2017.
(60) Provisional application No. 62/482,450, filed on Apr. 6, 2017.
(60) Provisional application No. 62/482,891, filed on Apr. 7, 2017.
(60) Provisional application No. 62/550,711, filed on Aug. 28, 2017.

(51) Int. Cl. H01M 10/0569; H01M 10/0525; H01M 4/38; H01M 10/42

(52) U.S. Cl. CPC H01M 10/0569; H01M 10/0525; H01M 4/386; H01M 2004/027; H01M 10/4235; H01M 2300/0037; H01M 4/387

(57) ABSTRACT

Electrolytes are provided, as well as fast charging lithium ion batteries with the electrolytes and corresponding methods—which enhance the safety and performance of the fast charging lithium ion batteries. The electrolytes comprise four-carbon chain ester(s) such as ethyl butyrate and/or butyl acetate as a significant part of the linear solvent (e.g., at least half and up to the full volume) and possibly vinyl carbonate as the cyclic carbonate solvent, in addition to lithium salt(s) and possibly additives. The use of vinyl carbonate enhances the ion conductivity of the electrolyte, while the use of four-carbon chain ester(s) such as ethyl butyrate and/or butyl acetate enhances the safety of the battery.

### CROSS REFERENCE TO RELATED APPLICATIONS

This application is a Continuation in Part of U.S. patent application Ser. No. 15/844,689, filed on Dec. 18, 2018, which is a continuation-in-part of U.S. application Ser. No. 15/447,889, filed on Mar. 2, 2017, and a continuation-in-part of U.S. application Ser. No. 15/447,784, filed on Mar. 2, 2017, both claiming the benefit of U.S. Provisional Application Nos. 62/319,341, filed Apr. 7, 2016, 62/337,416, filed May 17, 2016. 62/371,874, filed Aug. 8, 2016, 62/401,214, filed Sep. 29, 2016, 62/401,635, filed Sep. 29, 2016, 62/421,290, filed Nov. 13, 2016, 62/426,625, filed Nov. 28, 2016, 62/427,856, filed Nov. 30, 2016, 62/435,783, filed Dec. 18, 2016 and 62/441,458, filed Jan. 2, 2017, this application further claims the benefit of U.S. Provisional Application Nos. 62/482,450, filed on Apr. 6, 2017, 62/482,891, filed on Apr. 7, 2017 and 62/550,711, filed on Aug. 28, 2017, all of which are hereby incorporated by reference.

### BACKGROUND OF THE INVENTION

### 1. Technical Field

The present invention relates to the field of energy storage, and more particularly, to electrolytes for lithium ion batteries.

### 2. Discussion of Related Art

Lithium ion batteries are used for a growing range of applications, as their safety and performance are improved. The electrolytes of lithium ion batteries are an important component that affects their safety and performance.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides an electrolyte solution comprising linear solvent comprising at least one four-carbon chain ester, cyclic carbonate solvent comprising at least vinyl carbonate (VC), and at least one lithium salt.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a graph comparing the evaporation temperature for disclosed 30% VC, 35% EtBut, 35% ButAc (VC-EtBut-ButAc) electrolyte compared to VC-EMC electrolyte, according to some embodiments of the invention.

FIG. 2 is a graph comparing the heat flow in Differential Scanning calorimetry (DSC) measurements for disclosed 30% VC, 35% EtBut, 35% ButAc (VC-EtBut-ButAc) electrolyte compared to VC-EMC electrolyte, according to some embodiments of the invention.

FIG. 3 is a graph comparing the number of cycles for cells after formation, with disclosed 30% VC, 35% EtBut, 35% ButAc (VC-EtBut-ButAc) electrolyte compared to VC-EMC electrolyte, according to some embodiments of the invention.

FIG. 4 is a high-level flowchart illustrating a method, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have, been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for enhancing the safety and performance of the fast charging lithium ion batteries and thereby provide improvements to the technological field of energy storage. Disclosed electrolytes comprise four-carbon chain ester such as ethyl butyrate and/or butyl acetate as a significant part of the linear solvent (e.g., at least half and up to the full volume) and possibly vinyl carbonate as the cyclic carbonate solvent, in addition to lithium salt(s) and possibly additives. The use of vinyl carbonate enhances the ion conductivity of the electrolyte, while the use of four-carbon chain ester(s) such as ethyl butyrate and/or butyl acetate enhances the safety of the battery.

Electrolytes for fast charging lithium ion batteries comprise solvents, lithium salt(s) and additives. The solvents are selected to comply with safety and performance criteria for the final electrolyte mixture. Examples for such criteria comprise a low enough melting point (e.g., −20° C., −30° C. or lower, to prevent freezing), a high enough boiling point (e.g., passing a standard test at 130° C., to enable a sufficient range of operation temperatures) and a sufficiently high flash point (e.g., 20° C., 30° C., or higher, to prevent spontaneous ignition). Moreover, the solvents are selected to have sufficiently low viscosity and density to provide the required ionic conductivity for the lithium ions moving through the electrolyte. The latter performance criteria become more stringent as the fast charging rates are increased.

Fast charging cells may be charged at rates higher than 5 C, e.g., 1.0 C, 30 C or 100 C, with C denoting the rate of charging and/or discharging of cell/battery capacity, e.g., 10 C denotes charging and/or discharging the full cell capacity in 1/10 of an hour. Fast charging cells may comprise rechargeable Li-ion cells having anode material based on metalloids such as Si, Ge and/or Sn, as taught e.g., by any of U.S. Pat. Nos. 9,472,804 and 10,096,859, and U.S. patent applications Ser. Nos. 15/480,888, 15/414,655 and 15/844,689, which are incorporated herein by reference in their entirety.

Typically, the main electrolyte solvents are (i) cyclic carbonates which provide high lithium ion conductivity yet typically do not comply with the temperature requirements when used as single electrolyte components (examples: ethylene carbonate (EC), fluoroethylene carbonate (FEC) or vinylene carbonate (VC)); and (ii) linear carbonates which dilute the cyclic carbonates as solvents in the electrolyte to reach compliance with the temperature and conductivity criteria (examples: dimethyl carbonate (DMC), diethyl carbonate (DEC), ethyl methyl carbonate (EMC)). However, such linear carbonates may reduce the compliance of the solvent with the safety criteria or even cause the electrolyte to fall short of the safety criteria. It is noted that as the charging or discharging rates of the lithium ion batteries increase, performance and safety requirements from the electrolyte solvent increase.

In certain embodiments, esters may also be used as the linear components, e.g., ethyl acetate (EA) disclosed herein. In certain embodiments, three carbon chain esters (e.g., propionates) may be used to replace some or all of the linear electrolyte components due to their higher boiling and flash points, and lower melting points. In certain embodiments, four-carbon chain esters (e.g., butyrates) such as ethyl butyrate (EtBut) and butyl acetate (ButAc) may be used to replace at least a part of the linear component in the electrolyte solvent. Specifically, electrolytes with VC and ethyl butyrate and/or butyl acetate as main components are disclosed, and were found to comply with the safety and performance requirements of fast charging lithium ion batteries.

Certain embodiments comprise an electrolyte solution comprising linear solvent comprising at least one four-carbon chain ester, cyclic carbonate solvent comprising at least vinyl carbonate (VC), and at least one lithium salt. In some embodiments, ethyl butyrate and/or butyl acetate may be used as the four-carbon chain ester(s). In some embodiments, the ethyl butyrate may be at an amount between 20-50 vol % or between 20-80 vol % of the electrolyte solution, in some embodiments, the butyl acetate may be at an amount between 20-50 vol % or between 20-80 vol % of the electrolyte solution. In some embodiments, the VC may be at an amount between 20-40 vol % of the electrolyte. For example, the electrolyte solvent may comprise 30 vol % VC and 70 vol % of a combination of ethyl butyrate and butyl acetate.

In certain embodiments, the linear solvent may further comprise at least one linear carbonate solvent such as DMC, EMC and/or DEC, at an amount of 35 vol % or less of the electrolyte. For example, the electrolyte solvent may comprise 30 vol % VC and 35 vol % of a combination of ethyl butyrate and butyl acetate.

In any of the embodiments, the electrolyte may further comprise additives at an amount smaller than 2 wt % or smaller than 5 wt %.

Certain embodiments comprise a lithium ion battery comprising any of the disclosed electrolyte solutions, at least one anode and at least one cathode separated by at least one separator, wherein the anode has anode material based on metalloids comprising at least one of Si, Ge and/or Sn, and the battery is chargeable at least at 10 C.

In the following, three criteria were checked for disclosed electrolytes in comparison to VC-EMC electrolyte solvents (including 30% VC, 70% EMC) for fast charging lithium ion batteries having metalloid anodes.

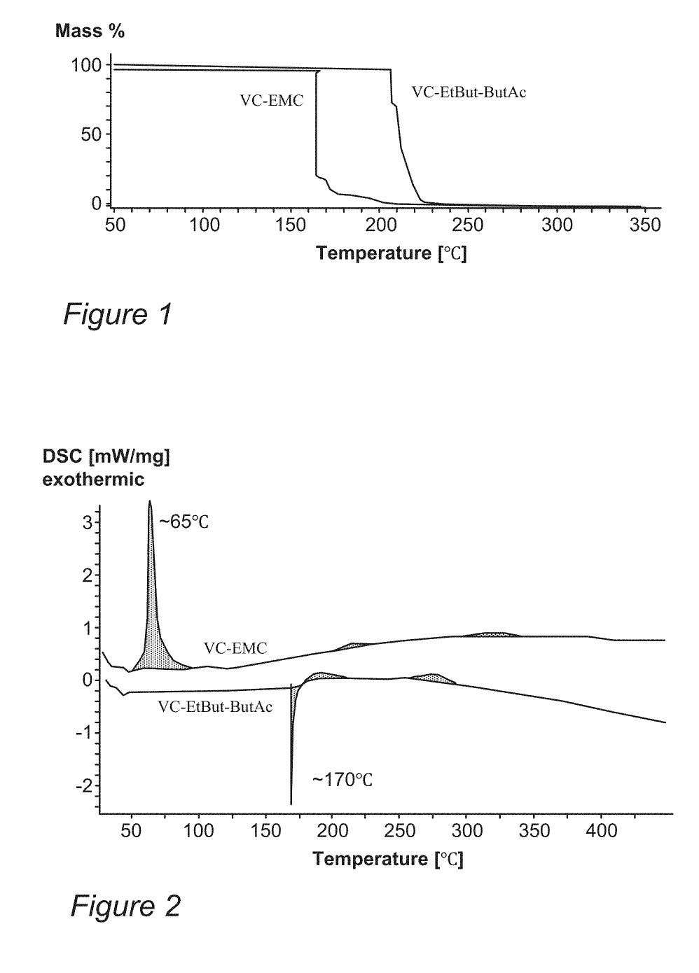

FIG. 1 is a graph comparing the evaporation temperature for disclosed 30% VC, 35% EtBut, 35% ButAc (VC-EtBut-ButAc) electrolyte compared to VC-EMC electrolyte, according to some embodiments of the invention. The evaporation temperature, in which the mass loss from 100% to 0 occurs (lines slightly shifted to be distinguishable) and which are related to the electrolyte's boiling point, is higher (at ca. 210-220° C.) for disclosed VC-EtBut-ButAc electrolyte than for VC-EMC electrolyte (at ca. 160-170V), suggesting that safety is improved using the disclosed solvents. The data was derived using thermogravimetric analysis (TGA), with Mass (%) denoting the percentage of initial mass as it depends on the temperature, with full evaporation corresponding to 100% mass loss. Similar data indicated increased safety for other disclosed variants as well, such as 30% VC, 70% EtBut and 30% VC, 35% EtBut, 35%EMC and 30% VC, 70% ButAc as solvents (% are vol %).

FIG. 2 is a graph comparing the heat flow in Differential Scanning calorimetry (DSC) measurements for disclosed 30% VC, 35% EtBut, 35% ButAc (VC-EtBut-ButAc) electrolyte compared to VC-EMC electrolyte, according to some embodiments of the invention. The flash point is higher (at ca. 170° C.) for disclosed VC-EtBut-ButAc electrolyte than for VC-EMC electrolyte (at ca. 65° C.), also suggesting that safety is improved using the disclosed solvents.

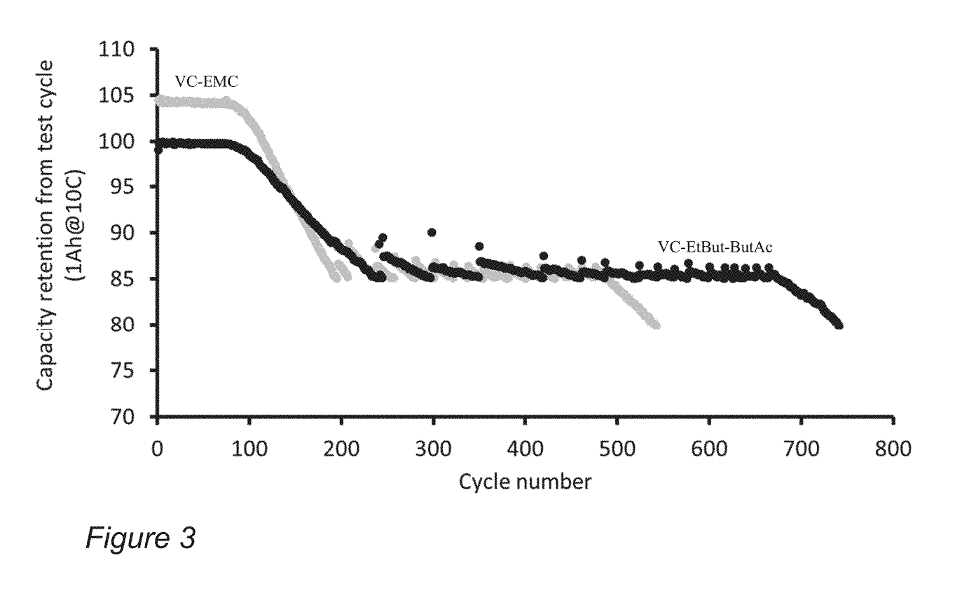

FIG. 3 is a graph comparing the number of cycles for cells after formation, with disclosed 30% VC, 35% EtBut, 35% ButAc (VC-EtBut--ButAc) electrolyte compared to VC-EMC electrolyte, according to some embodiments of the invention. The graph illustrates the comparative performance of disclosed electrolytes, under fast charging conditions (10 C) of full cells with lAh capacity, having germanium-based anode material, and NCA (Nickel Cobalt Aluminum Oxide)-based cathode material. Disclosed VC-EtBut-ButAc electrolyte outperforms the VC-EMC electrolyte by ca. 35% in cycling lifetime (ca. 750 cycles versus ca. 550 cycles), a difference which is significant as one of the barriers to wider use of lithium ion batteries is their cycling lifetime.

Accordingly, disclosed electrolytes were found to provide better safety and better performance than the baseline. Certain embodiments comprise lithium ion batteries with the disclosed electrolytes, anode(s) and cathode(s) separated by separator(s), with the anode having anode material based on metalloids comprising Si, Ge and/or Sn, and the battery being chargeable at least at 10 C.

The lithium ion batteries typically comprise anodes and cathodes with current collectors affixed thereto, packed with electrolyte and separator(s) in a battery pouch/hard case/coin. Anodes are typically made of anode material particles, conductive additive(s) and binder(s), and may comprise any of the anode configurations taught, e.g., by U.S. patent application Ser. No. 15/480,888, incorporated herein by reference in its entirety. For example, anodes may be based on graphite, graphene or metalloid anode material such as Si, Ge, Sn and their combinations. Cathodes may comprise materials based on layered, spinel and/or olivine frameworks, such as LCO formulations (based on LiCoO₂), NMC formulations (based on lithium nickel-manganese-cobalt), NCA formulations (based on lithium nickel cobalt aluminum oxides), LMO formulations (based on LiMn₂O₄), LMN formulations (based on lithium manganese-nickel oxides) LFP formulations (based on LiFePO4), lithium rich cathodes, and/or combinations thereof. Separator(s) may comprise various materials, e.g., polymers such as any of polyethylene (PE), polypropylene (PP), polyethylene terephthalate (PET), poly vinylidene fluoride (PVDF), polymer membranes such as a polyolefin, polypropylene, or polyethylene membranes. Multi-membranes made of these materials, micro-porous films thereof, woven or non-woven fabrics etc. may be used as separator(s), as well as possibly either coating or composite materials including, e.g., alumina, zirconia, titania, magnesia, silica and calcium carbonate along with various polymer components as listed above. Lithium electrolyte salt(s) may comprise LiPF₆, LiBF₄, lithium bis(oxalato)borate, LiN(CF₃SO₂)₂, LiN(C₂F₅SO₂)₂, LiAsF₆, LiC(CF₃SO₂)₃, LiClO₄, LiTFSl, LiB(C₂O₄)₂, LiBF₂(C₂O₄)), tris(trimethylsilyl)phosphite (TMSP), and combinations thereof. Ionic liquid(s) may be added to the electrolyte as taught by WIPO Application No. PCT/IL2017/051358, incorporated herein by reference in its entirety. Disclosed lithium ion batteries may be configured, e.g., by selection of materials, to enable operation at high charging and/or discharging rates (C-rate), ranging from 3-10 C-rate, 10-100 C-rate or even above 100 C, e.g., 5 C, 10 C, 15 C, 30 C or more. It is noted that the term C-rate is a measure of charging and/or discharging of cell/battery capacity, e.g., with 1 C denoting charging and/or discharging the cell in an hour, and XC (e.g., 5 C, 10 C, 50 C etc.) denoting charging and/or discharging cell in 1/× of an hour—with respect to a given capacity of the cell.

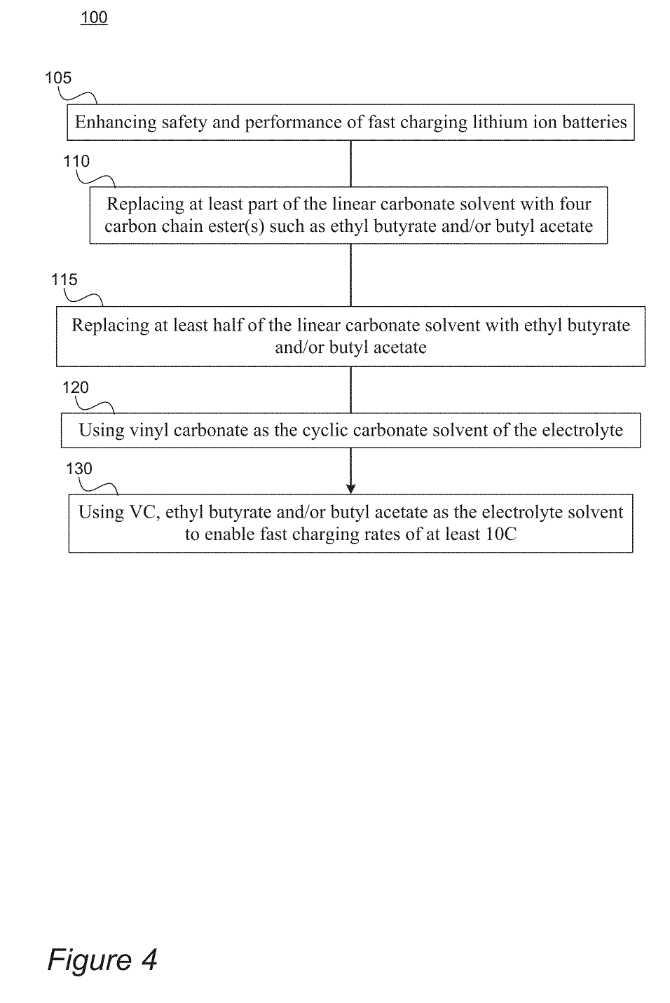

FIG. 4 is a high-level flowchart illustrating a method 100, according to some embodiments of the invention. The method stages may be carried out with respect to electrolytes described above, which may optionally be configured to implement method 100. Method 100 may comprise the following stages, irrespective of their order.

Method 100 comprises enhancing safety and performance of fast charging lithium ion batteries (stage 105), by replacing at least part of a linear solvent of an electrolyte with at least one four-carbon chain ester such as ethyl butyrate and/or butyl acetate (stage 110).

Method 100 may further comprise using vinyl carbonate as a cyclic carbonate solvent of the electrolyte solution (stage 120).

Method 100 may further comprise replacing at least half of the linear carbonate solvent with four-carbon chain ester(s) such as ethyl butyrate and/or butyl acetate (stage 115), e.g., using any of the electrolyte compositions described above.

In certain embodiments, method 100 may comprise using VC, ethyl butyrate and/or butyl acetate as electrolyte solvent to enable fast charging rates of at least 10 C (stage 130).

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An electrolyte solution comprising:
linear solvent comprising at least one four-carbon chain ester, cyclic carbonate solvent comprising at least vinyl carbonate (VC), and
at least one lithium salt.

2. The electrolyte solution of claim 1, wherein the at least one four-carbon chain ester comprises at least one of ethyl butyrate and butyl acetate.

3. The electrolyte solution of claim 2, wherein the ethyl butyrate is at an amount between 20-80 vol% of the electrolyte solution.

4. The electrolyte solution of claim 2, wherein the butyl acetate is at an amount between 20-80 vol % of the electrolyte solution.

5. The electrolyte solution of claim I, wherein the VC is at an amount between 20-40 vol % of the electrolyte solution.

6. The electrolyte solution of claim 1, comprising 30 vol % VC and 70 vol % of a combination of ethyl butyrate and butyl. acetate.

7. The electrolyte of claim 1, wherein the linear solvent further comprises at least one of DMC, EMC and DEC, at an amount of 35 vol % or less of the electrolyte solution.

8. The electrolyte solution of claim 7, further comprising 30vol % VC and 35 vol % of a combination of ethyl butyrate and butyl acetate.

9. The electrolyte solution of claim 1, further comprising additives at an amount smaller than 5 wt %.

10. A lithium ion battery comprising the electrolyte solution of claim 1, at least one anode and at least one cathode separated by at least one separator, wherein the anode has anode material based on metalloids comprising at least one of Si, Ge and/or Sn, and the battery is chargeable at least at 10 C.

11. A method of enhancing safety and performance of fast charging lithium ion batteries, the method comprising replacing at least part of a linear solvent of an electrolyte with at least one four-carbon chain ester.

12. The method of claim 11, further comprising using vinyl carbonate as a cyclic carbonate solvent of the electrolyte.

13. The method of claim 11, further comprising replacing at least half of the linear solvent with ethyl butyrate and/or butyl acetate.

14. The method of claim 11, further comprising using VC and at least one four-carbon chain ester as electrolyte solvent to enable fast charging rates of at least 10 C.

15. The method of claim 14, further comprising using VC, ethyl butyrate and/or butyl acetate as electrolyte solvent to enable fast charging rates of at least 10 C.
